(19) United States
(12) Patent Application Publication
(10) Pub. No.: US 2024/0404299 A1
(43) Pub. Date: Dec. 5, 2024

(54) PERCEPTION AND UNDERSTANDING OF ROAD USERS AND ROAD OBJECTS

(71) Applicant: GM Cruise Holdings LLC, San Francisco, CA (US)

(72) Inventors: Yifeng Zeng, Sunnyvale, CA (US); Gweltaz Lever, San Francisco, CA (US); Shuqin Xie, Sunnyvale, CA (US); Jianqiao Feng, Sunnyvale, CA (US); Xi Yi, Mountain View, CA (US)

(73) Assignee: GM Cruise Holdings LLC, San Francisco, CA (US)

(21) Appl. No.: 18/326,740

(22) Filed: May 31, 2023

(51) Int. Cl. G06V 20/58; B60W 60/00

(52) U.S. Cl. CPC G06V 20/582; B60W 60/001; B60W 2420/403; B60W 2554/4049

(57) ABSTRACT

Autonomous vehicles utilize perception and understanding of road users and road objects to predict behaviors of the road users and road objects, and to plan a trajectory for the vehicle. Improved perception and understanding of the AV's surroundings can improve the AV's behavior around drivable objects, non-drivable road objects, construction zones, and temporary road closures. Improved perception and understanding of the AV's surroundings can also reduce the chances of the AV getting stuck and the need to be retrieved physically. To offer additional understanding capabilities, an additional understanding model is added to the perception and understanding pipeline to improve classification of road objects and extraction of attributes of the road objects. The implementation of the understanding model itself and placement of the model within the pipeline balance recall and precision performance metrics and computational complexity.

### BACKGROUND

### Technical Field

The present disclosure generally relates to autonomous vehicles (AVs) and, more specifically, to understanding of road users and road objects by AVs.

### Introduction

AVs, also known as self-driving cars, and driverless vehicles, may be vehicles that use multiple sensors to sense the environment and move without human input. Automation technology in AVs may enable vehicles to drive on roadways and to accurately and quickly perceive the vehicle's environment, including obstacles, signs, and traffic lights. Autonomous technology may utilize geographical information and semantic objects (such as parking spots, lane boundaries, intersections, crosswalks, stop signs, and traffic lights) for facilitating vehicles in making driving decisions. The vehicles can be used to pick up passengers and drive the passengers to selected destinations. The vehicles can also be used to pick up packages and/or other goods and deliver the packages and/or goods to selected destinations.

### BRIEF DESCRIPTION OF THE DRAWINGS

The various advantages and features of the present technology will become apparent by reference to specific implementations illustrated in the appended drawings. A person of ordinary skill in the art will understand that these drawings show only some examples of the present technology and would not limit the scope of the present technology to these examples. Furthermore, the skilled artisan will appreciate the principles of the present technology as described and explained with additional specificity and detail through the use of the accompanying drawings.

FIG. 1 illustrates an exemplary AV stack and an AV, according to some aspects of the disclosed technology.

FIG. 2 illustrates an exemplary implementation of perception, understanding, and tracking part 104, prediction part 106, and planning part 110, according to some aspects of the disclosed technology.

FIG. 3 illustrates an exemplary implementation of understanding part 204, tracking part 104, prediction part 106, and planning part 110, according to some aspects of the disclosed technology.

FIG. 4 illustrates an exemplary taxonomy of classes and attributes that road object understanding sub-model 304 can generate, according to some aspects of the disclosed technology.

FIG. 5 illustrates an exemplary architecture for the road object understanding sub-model 304, according to some aspects of the disclosed technology.

FIG. 6 illustrates another exemplary architecture for the road object understanding sub-model 304, according to some aspects of the disclosed technology.

FIG. 7 illustrates an exemplary method for understanding road users and road objects and controlling a vehicle based on the understanding, according to some aspects of the disclosed technology.

FIG. 8 illustrates an exemplary system environment that may be used to facilitate AV operations, according to some aspects of the disclosed technology.

FIG. 9 illustrates an exemplary computing system with which some aspects of the subject technology may be implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details that provide a more thorough understanding of the subject technology. However, it will be clear and apparent that the subject technology is not limited to the specific details set forth herein and may be practiced without these details. In some instances, structures and components are shown in block diagram form to avoid obscuring the concepts of the subject technology.

### Overview

AVs can provide many benefits. For instance, AVs may have the potential to transform urban living by offering an opportunity for efficient, accessible, and affordable transportation. AVs utilize perception and understanding of road users and road objects to predict behaviors of the road users and road objects, and to plan a trajectory for the vehicle. In some cases, prediction, planning, and control may depend on how well certain types of road objects (e.g., construction zone traffic signs and objects) are classified. Improved perception and understanding of the AV's surroundings can improve the AV's behavior around drivable objects, non-drivable road objects, construction zones, and temporary road closures. Improved perception and understanding of the AV's surroundings can also reduce the chances of the AV getting stuck and the need to be retrieved physically.

To offer additional understanding capabilities, a road object understanding model can be added to the perception and understanding pipeline to improve classification of road objects and extraction of attributes of the road objects. The implementation of the road object understanding model itself and placement of the road object model within the pipeline balance recall and precision performance metrics and computational complexity. The road object understanding model may serve as a sub-model to a main understanding model. Other sub-models may consume outputs of the road object understanding model, if desired.

The road object understanding model can output inferences such as road object classification and extraction of road object attributes. The road object understanding model can extract a rich taxonomy that would benefit downstream consumers of the information, such as traffic directives understanding, prediction of objects' behavior and movements, and planning of the AV. The taxonomy can include different classes of road objects or road object subtypes classifications (or classes), e.g., debris, animal, construction object, sign, vulnerable road users, etc. Taxonomy may include sub-classes or attributes for signs, where the sub-classes can include road closed sign, stop sign, keep left sign, keep right sign, and double arrow sign. The taxonomy can include different attributes of road objects, e.g., drivability, rigidity, emptiness, material, animal can fly, etc. The road object understanding model can be implemented as a multi-task model that has a shared backbone and multiple heads that are dedicated to tasks such as generating different road object classifications and extracting different road object attributes. The use of a shared backbone may prevent overfitting, when compared with the alternative of having separate models for each task. Because the road object understanding model focuses on tasks that are all addressing challenging road objects, the shared backbone may learn features which are common to these tasks, while leaving the heads to learn features which are unique to the specific tasks. Having multiple heads dedicated to different tasks may improve precision and recall performance metrics of the classifications and attributes specific to those tasks. One or more temporal networks can be included at the output of the shared backbone and in front of the multiple heads to learn features that may be dynamic (e.g., varies over time), or have kinematic behaviors. Multiple tasks can share the same temporal network. Some tasks may have dedicated temporal networks. The dedicated temporal networks may be configured differently depending on the task.

The road object understanding model can be a sub-model of a main understanding model. The main understanding model can classify tracked objects into different road user classifications and an unknown object classification. The sub-model can produce classifications and attributes for tracked objects that had been assigned an unknown object classification. Precision and recall precision metrics may be improved when the sub-model is not concerned with predicting main road user classes (since that is performed by the main understanding model). By design, the sub-model can focus on producing classifications and attributes for a subset of tracked objects, and not all of the tracked objects. An understanding model that processes every tracked object would consume significantly more computational resources of the system than a sub-model that only processes a subset of tracked objects. Providing a sub-model that is focused on tracked objects that are assigned an unknown object classification by the main understanding model can mean that the sub-model can serve as an additional gate to recall misclassified road object subtypes that were previously misclassified as unknown by the main understanding model. The combination of the main understanding model and the sub-model may make the perception and understanding pipeline in the AV more robust.

The road object understanding model may operate after tracking has been completed. The road object understanding model may receive and process sensor data that is cropped based on bounding boxes of tracked objects having the unknown object classification, so that the understanding model does not need to process uncropped sensor data, which would have increased computational complexity.

The output inferences of the road object understanding model, in some cases, can be provided to one or more further sub-models for understanding an environment of the vehicle. For example, sign classification, sub-classes for signs, and/or attributes for signs produced by the road object understanding model can be provided to a traffic directives understanding sub-model, which may generate further understanding information to assist the planning of an AV.

Various embodiments herein and their advantages may apply to a wide range of vehicles (e.g., semi-autonomous vehicles, vehicles with driver-assist functionalities, etc.), and not just AVs.

Exemplary AV and an AV Stack that Controls the AV

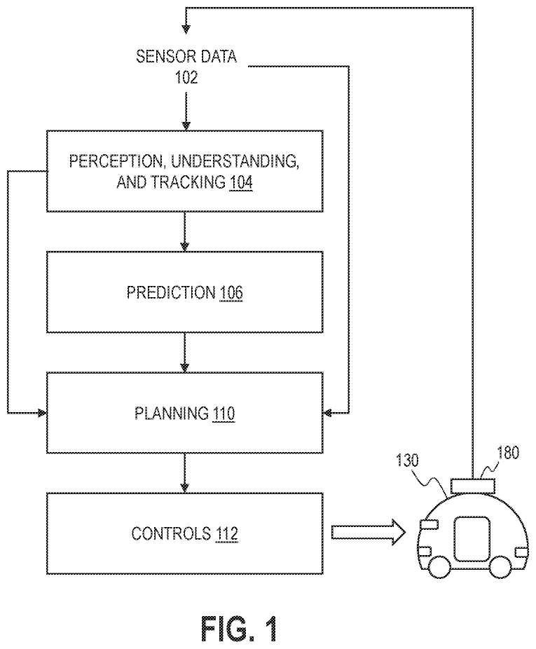

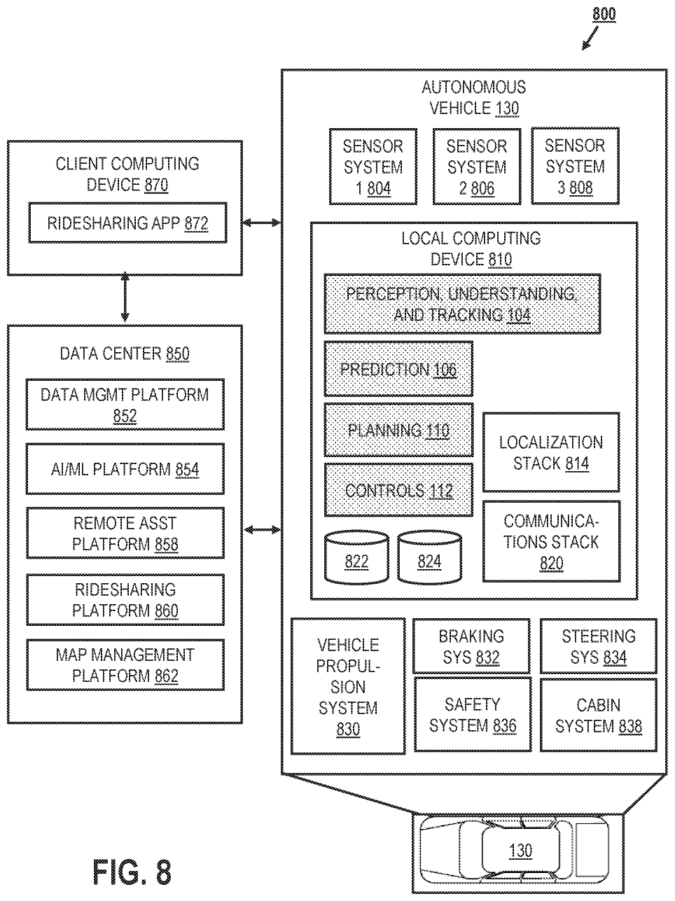

FIG. 1 illustrates an exemplary AV stack and an AV 130, according to some aspects of the disclosed technology. An AV 130 may be equipped with a sensor suite 180 to sense the environment surrounding the AV and collect information (e.g., sensor data 102) to assist the AV in making driving decisions. The sensor suite 180 may include, e.g., sensor systems 804, 806, and 808 of FIG. 8. The AV stack may include perception, understanding, and tracking part 104, prediction part 106, planning part 110, and controls part 112. The sensor data 102 may be processed and analyzed by perception, understanding, and tracking part 104 to track objects in the environment of the AV and determine a perception and understanding of the environment of the AV 130. Prediction part 106 may determine future motions and behaviors of the AV and/or tracked objects in the environment of the AV 130. The AV 130 may localize itself based on location information (e.g., from location sensors) and the map information. The planning part 110 may create planned paths or trajectories based on one or more of: information from perception, understanding, and tracking part 104, information from prediction part 106, the sensor data 102, map information, localization information, etc. Subsequently, planned paths or trajectories can be provided to controls part 112 to generate vehicle control commands to control the AV 130 (e.g., for steering, accelerating, decelerating, braking, turning on vehicle signal lights, etc.) according to the planned path.

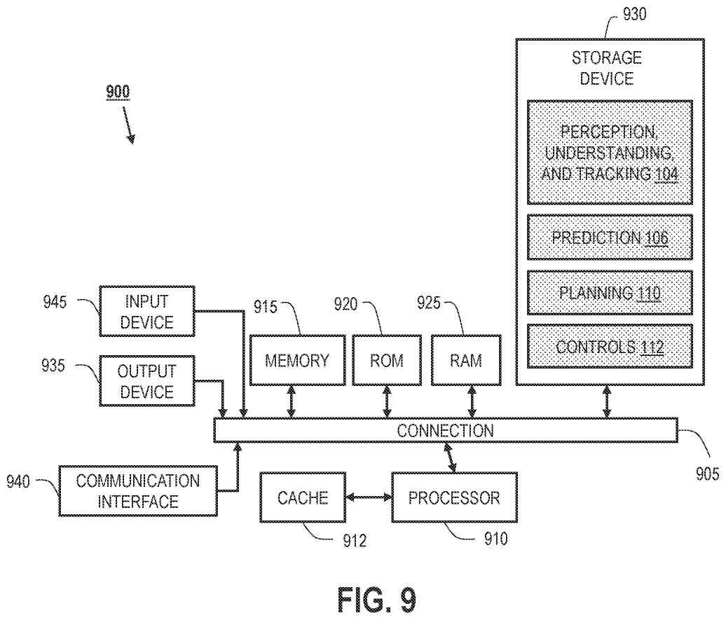

The operations of components of the AV stack may be implemented using a combination of hardware and software components. For instance, an AV stack performing the perception, understanding, prediction, planning, and control functionalities may be implemented as software code or firmware code encoded in non-transitory computer-readable medium. The code for AV stack may be executed on one or more processor(s) (e.g., general processors, central processors (CPUs), graphical processors (GPUs), digital signal processors (DSPs), ASIC, etc.) and/or any other hardware processing components on the AV. Additionally, the AV stack may communicate with various hardware components (e.g., on-board sensors and control system of the AV) and/or with an AV infrastructure over a network. At least a part of the AV stack may be implemented on local computing device 810 of FIG. 8. At least a part of the AV stack may be implemented on the computing system 900 of FIG. 9 and/or encoded in instructions of storage device 930 of FIG. 9.

### Exemplary Perception, Understanding, and Tracking Architecture

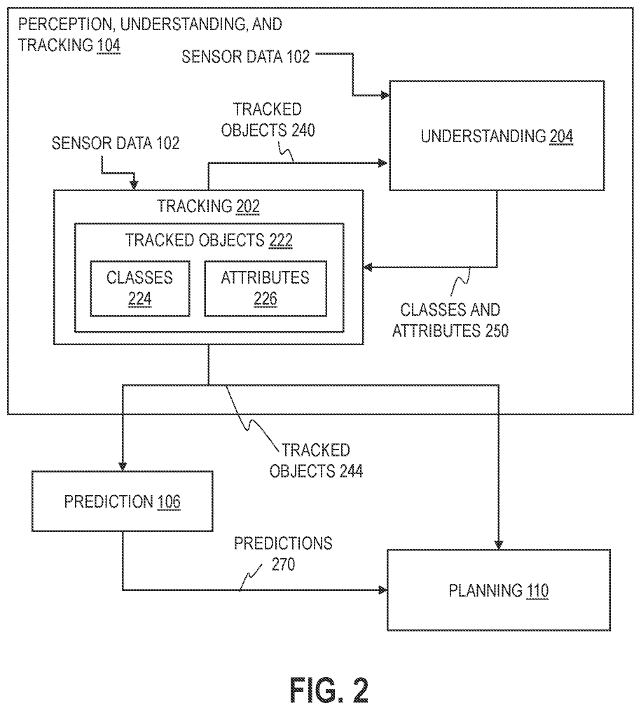

FIG. 2 illustrates an exemplary implementation of perception, understanding, and tracking part 104, prediction part 106, and planning part 110, according to some aspects of the disclosed technology. The figure illustrates one exemplary configuration and arrangement of parts within an AV stack and is not intended to be limiting to the disclosure.

Perception, understanding, and tracking part 104 may include tracking part 202 and understanding part 204. Tracking part 202 may receive sensor data 102 from a sensor suite of an AV (the sensor suite may include, e.g., sensor systems 804, 806, and 808 of FIG. 8). Tracking part 202 may determine from the sensor data 102 presence of objects in an environment of the AV and track the objects presence over time (or across frames of data). The presence of an object can be encoded as a bounding box defining boundaries and location of an object in a three-dimensional space. The presence of an object can be encoded as location information and size information that specify the object's occupancy in space.

Understanding part 204 may receive sensor data 102 and optionally tracked objects information 240 (of tracked objects 222) to understand the objects in the environment of the AV. Understanding part 204 may process sensor data 102, e.g., using one or more machine learning models, to produce inferences about the tracked objects 222, such as one or more classes and/or one or more attributes for tracked objects 222. Understanding part 204 may provide classes and attributes 250 as feedback information to tracking part 202. Directly or indirectly, classes and attributes 250 produced by understanding part 204 may be provided to prediction part 106 and/or planning part 110 to assist prediction and/or planning functionalities respectively.

As illustrated in the figure, tracking part 202 may serve as a classes and attributes collector and can collect and maintain classes 224 and/or attributes 226 for tracked objects 222. The objects and information associated with the objects may be maintained as tracked objects 222 in tracking part 202. Tracked objects 222 may be in a format of a database or collection of data that includes data entries for tracked objects 222, where each data entry for a tracked object may include information for the tracked object, such as an object identifier of the tracked object, bounding box of the tracked object, one or more classifications of the tracked object, and one or more attributes of the tracked object. Tracked objects 222 may be in a different format, e.g., such as a grid map or raster map of an environment surrounding the AV, whose pixels may store information for various tracked objects, such as an object identifier of the tracked object, bounding box of the tracked object, one or more classifications of the tracked object, and one or more attributes of the tracked object.

Perception, understanding, and tracking part 104 may provide tracked objects information 244 (of tracked objects 222) to prediction part 106. Perception, understanding, and tracking part 104 may provide tracked objects information 244 (of tracked objects 222) to planning part 110. Prediction part 106 may provide predictions 270 to planning part 110. Tracked objects information 240 and/or tracked objects information 244 may include at least some of the information maintained in tracked objects 222. Tracked objects information 244 provided from tracking part 202 to prediction part 106 and planning part 110 may include information produced by tracking part 202 and information produced by understanding part 204.

### Exemplary Understanding Part Having Multiple Models

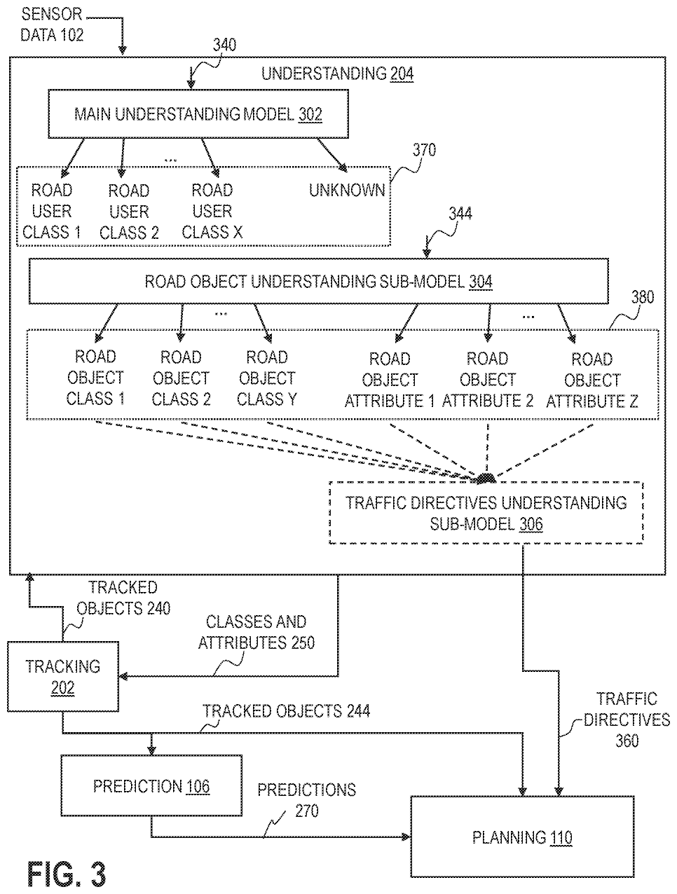

FIG. 3 illustrates an exemplary implementation of understanding part 204, tracking part 104, prediction part 106, and planning part 110, according to some aspects of the disclosed technology. The parts may form at least a part of an AV stack for an AV (not shown). The AV may have sensors, one or more processors, and one or more storage media encoding instructions executable by the one or more processors to implement one or more parts of the AV stack, such as the parts illustrated in the figure. The sensors may include, e.g., sensor systems 804, 806, and 808 of FIG. 8. The one or more processors and the one or more storage media may be an exemplary implementation of local computing device 810 of FIG. 8. The one or more processors and the one or more storage media may be an exemplary implementation of the computing system 900 of FIG. 9. One or more models may be machine learning models.

The understanding part 204 may include a main understanding model 302 and a road object understanding sub-model 304. The main understanding model 302 may classify a tracked object into one of: a plurality of road user classifications and an unknown object classification. Main understanding model 302 may receive sensor data 340 that corresponds to a tracked object, such as a tracked object that has not yet been classified by an understanding model (e.g., tracking part 202 may have detected the presence of the tracked object, and understanding part 204 has not yet produced an inference). Main understanding model 302 may have one or more outputs 370 that produce one or more inferences on the tracked object, e.g., whether the tracked object represented in the input sensor data 340 belongs to one or more road object subtype classes or classifications. As illustrated, main understanding model 302 may output an inference that assigns the tracked object to one of several classes, e.g., road user class 1, road user class 2, . . . road user class X, and unknown class. Preferably, the main understanding model 302 can identify road users in the environment of the AV. Examples of road user classes may include: pedestrian, bicyclist, unicyclist, person on scooter, motorcyclist, vehicle, etc. Examples of unknown object classifications may include unknown object, dynamic unknown object (e.g., moving unknown object), and static unknown object (e.g., stationary unknown object). Inferences from one or more outputs 370 may be provided to tracking part 202.

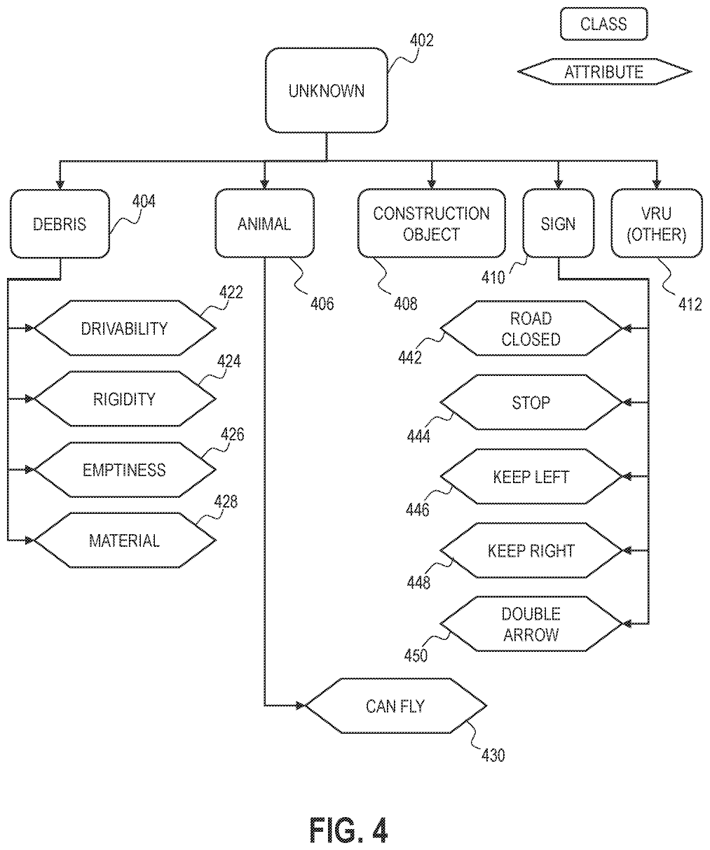

The road object understanding sub-model 304 may classify a tracked object with an unknown object classification assigned or inferred by the main understanding model 302, into one or more road object classes. The road object understanding sub-model 304 may extract one or more road object attributes about the tracked object. Road object understanding sub-model 304 may receive sensor data 344 (generated from the sensors of the AV) corresponding to tracked objects having the unknown object classification, such as a tracked object that has been classified by main understanding model 302 as having an unknown object classification). Road object understanding sub-model 304 may have one or more outputs 380 that produce one or more inferences on the tracked object having an unknown object classification. Exemplary inferences may include whether the tracked object represented in the input sensor data 344 belongs to one or more classes or classifications. Exemplary inferences may include whether the tracked object represented in the input sensor data 344 has certain road object attributes or properties. As illustrated, road object understanding sub-model 304 may output an inference that assigns the tracked object having an unknown classification to one of several classes, e.g., road object class 1, road object class 2, . . . and road object class Y. The road object understanding sub-model 304 may output inferences about one or more attributes (or properties) of the tracked object, e.g., road object attribute 1, road object attribute 2 . . . and road object attribute Z. Outputs 380, e.g., encoding inferences of road object understanding sub-model 304, may indicate discrete classes (e.g., a class) and/or continuous values (e.g., a probability or likelihood). Exemplary road object classes/classifications and exemplary road object attributes are illustrated in FIG. 4.

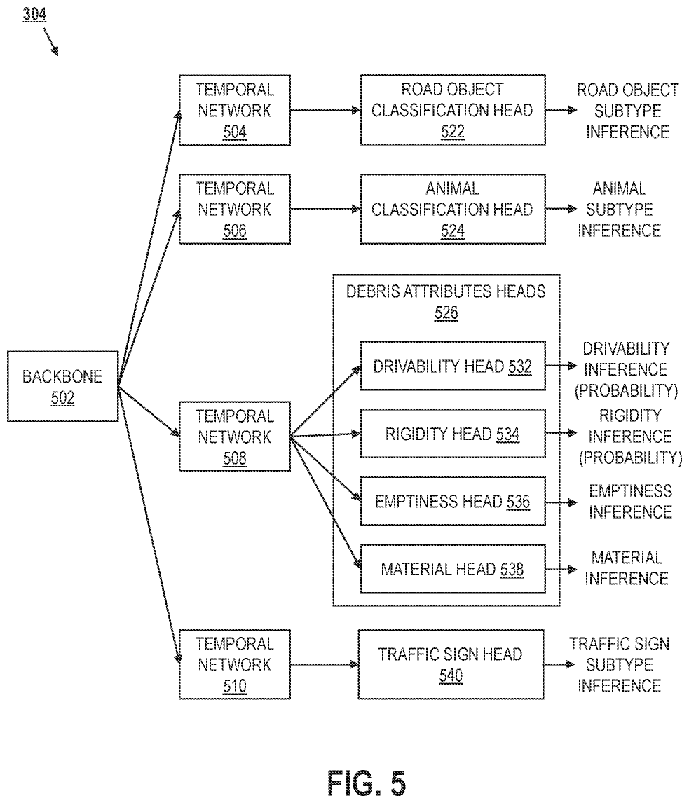

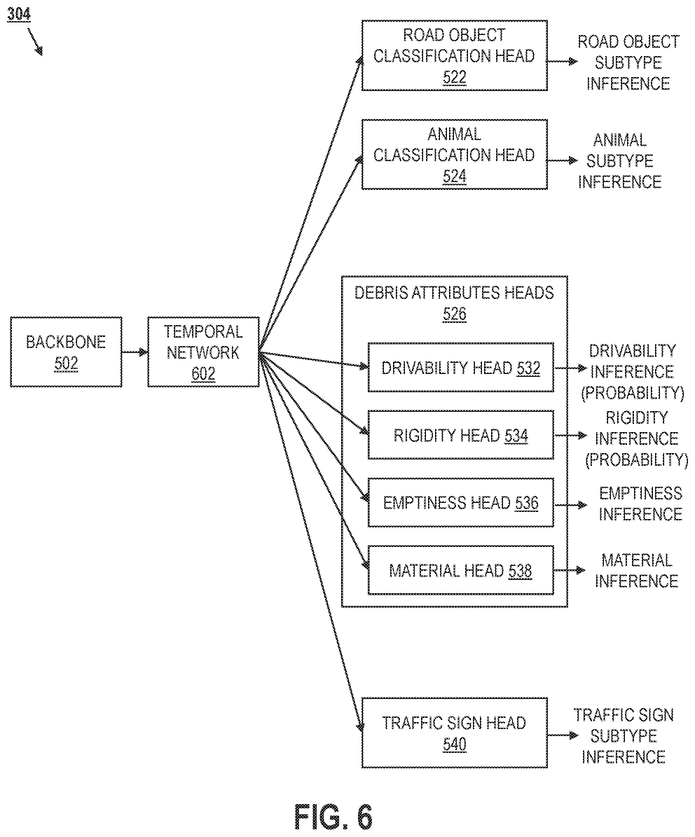

Road object understanding sub-model 304 may be a multi-task learning model to generate inferences on a set of unknown road objects, and produce meaningful and rich inferences that can support other parts of the AV stack. Road object understanding sub-model 304 may include a shared backbone and a plurality of heads. The shared backbone may receive and process sensor data generated from the sensors corresponding to tracked objects having the unknown object classification. The plurality of heads may output inferences including one or more road object classifications and one or more road object attributes. Exemplary architectures for the road object understanding sub-model 304 are illustrated and described with FIGS. 5-6.

Inference(s) produced by road object understanding sub-model 304 can advantageously be used by one or more downstream models, e.g., downstream understanding models in understanding part 204, to better understand the environment surrounding an AV. In some embodiments, understanding part 204 may include traffic directives understanding sub-model 306. Traffic directives understanding sub-model 306 may process sensor data and/or other information to understand situations on the road such as (temporary) traffic restrictions, construction zones, emergency traffic restrictions, emergency or law enforcement personnel, persons directing traffic, etc. The traffic directives understanding sub-model 306 may receive one or more inferences from the road object understanding sub-model 304, e.g., a traffic sign inference from a traffic sign head of the road object understanding sub-model 304. The traffic directives understanding sub-model 306 may produce one or more traffic directives 360 to the planning part 110.

In some embodiments, tracking part 202 may produce bounding boxes of tracked objects in an environment of the vehicle. The bounding boxes of tracked objects can be provided to the understanding part 204. The sensor data 344 at the input of road object understanding sub-model 304 from the sensors corresponding to the tracked objects having the unknown object classification may be cropped. For example, sensor data 344 may include camera images cropped based on projections of bounding boxes of the tracked objects having the unknown object classification onto camera images captured by the sensors. Processing cropped images (as opposed to full images) can reduce computational complexity.

In some embodiments, the inferences of the understanding part 204 (e.g., inferences from main understanding model 302, inferences from road object understanding sub-model, and inferences from traffic directives understanding sub-model 306) can be provided to the tracking part 202. Inferences may be provided as classes and attributes 250 to tracking part 202. Tracking part 202 may be a collector for classes and attributes of various tracked objects.

Prediction part 106 may receive at least one of the inferences generated by the plurality of heads and to predict behaviors of tracked objects in an environment of the vehicle based on at least one of the inferences. Expected behaviors and movements of road objects can be different depending on the type of road object. Some inferences such as animal classification, debris classification, emptiness attribute, whether an animal can fly or not, may impact how prediction part 106 predicts future pose and future kinematics of various types of tracked objects. Tracked objects which are classified animals (e.g., raccoons, deer, bears, etc.) may have predicted behaviors and movements that are more erratic.

Planning part 110 may receive at least one of the inferences generated by the plurality of heads (or other models in understanding part 204) and generate a trajectory for the vehicle based on at least one of the inferences. Some inferences such as drivability, rigidity, and whether an animal can fly or not, may impact how planning part 110 generates planned paths for the AV. The planning part 110 may plan a path that has the AV driving over a tracked object that has a debris classification and has an attribute that indicates the tracked object is empty (as opposed to hard braking in front of the tracked object).

### Exemplary Taxonomy

FIG. 4 illustrates an exemplary taxonomy of classes and attributes that road object understanding sub-model 304 of FIG. 3 can generate, according to some aspects of the disclosed technology. The taxonomy tree as shown in the figure illustrates road object subtype classes or classifications and road object attributes that a road object understanding model (e.g., road object understanding sub-model 304 of FIG. 3) can produce. In some cases, attributes may represent sub-classes or sub-classifications of a road object subtype class.

For tracked objects having an unknown object classification 402 (assigned by a main understanding model of the understanding part 204), the road object understanding model may produce a road object subtype inference that that selects between two or more road object subtype classifications (e.g., outputs a classification to which a given tracked object most likely belong or has the best match). Examples of road object subtype classifications (or classes) include debris classification 404, animal classification 406, construction object classification 408, traffic sign classification 410, and vulnerable road user classification 412.

A main understanding model, e.g., main understanding model 302, may produce classifications that include types of construction objects, types of traffic signs, and types of vulnerable road users. To provide a construction object classification 408, traffic sign classification 410, and vulnerable road user classification 412, as some of the classifications that the road object understanding model can produce when processing tracked objects where the main understanding model has assigned an unknown object classification, the road object understanding model may offer an additional gate to recall misclassified construction objects, traffic signs, and vulnerable road users.

The road object understanding model may produce inferences for debris attributes (or debris subtype classes), such as drivability attribute 422, rigidity attribute 424, emptiness attribute 426, and material attribute 428. Other similar or opposite attributes are envisioned by the disclosure. Drivability attribute 422 may be a continuous value that represents a probability that an AV can drive over the tracked object. Drivability attribute 422 may indicate whether a tracked object has a drivable sub-classification or a not drivable sub-classification. Rigidity attribute 424 may be a continuous value that represents a probability that a tracked object is rigid, or how rigid a tracked object is. Rigidity attribute 424 may indicate whether a tracked object has a rigid (e.g., hard) sub-classification or a not rigid (e.g., soft) sub-classification. Emptiness attribute 426 may be a continuous value that represents a probability that a tracked object is empty, or how empty a tracked object is. Emptiness attribute 426 may indicate whether a tracked object has an empty sub-classification or a full sub-classification. Material attribute 428 may be an inference that indicates probabilities that a tracked object has a certain material, and/or which material may have the highest probability or closest match. Material attribute 428 may indicate whether a tracked object may belong to one of the following classes: cardboard attribute/classification, fabric attribute/classification, foliage attribute/classification, metal attribute/classification, paper attribute/classification, plastic attribute/classification, plastic attribute/classification, stone attribute/classification, wood attribute/classification, and unknown material attribute/classification. Debris attributes and debris subtype classes may benefit prediction part 106 and planning part 110 of FIG. 3, since the attributes and subtype classes may help better prediction of debris behavior and movements and may better allow an AV to create a plan that takes debris attributes into account. For example, prediction part 106 may predict a piece of paper will fly in front of the AV, and planning part 110 may create a plan for the AV to drive over the piece of paper.

The road object understanding model may produce inferences for animal attributes (or animal subtype classes), such as animal can fly attribute 430. Exemplary animal subtype classes may include animal can fly attribute/classification, animal cannot fly attribute/classification, ground animal attribute/classification, bird attribute/classification, reptile attribute/classification, large animal attribute/classification, small animal attribute/classification, domesticated animal attribute/classification, protected animal attribute/classification, invasive species animal attribute/classification, and unknown animal attribute/classification. Animal attributes and animal subtype classes may benefit prediction part 106 of FIG. 3, since the attributes and subtype classes may help better prediction of animal behavior and movements and may better allow an AV to create a plan that takes animal attributes into account. For example, prediction part 106 may predict a deer will stop in the middle of the road, and planning part 110 may create a plan for the AV to not collide with the deer.

The road object understanding model may produce inferences for traffic sign attributes (or traffic sign subtype classes), such as a road closed sign attribute/classification 442, a stop sign attribute/classification 444, a keep left sign attribute/classification 446, a keep right sign attribute/classification 448, a double arrow sign attribute/classification 450, and an unknown sign classification (not shown).

### Exemplary Multi-Task Learning Architectures for Road Object Understanding Model

Road object understanding model can be implemented as a multi-task learning model. The architecture of the multi-task learning model may include shared layers (e.g., a shared backbone) and task-specific layers (e.g., heads). The shared backbone can receive and process sensor data generated from the sensors corresponding to tracked objects having the unknown object classification. The shared backbone may include a deep neural network, such as multi-layer perceptrons, convolutional neural networks, and recurrent neural networks. The shared backbone may include a residual network, which can be beneficial for processing sensor data including camera images. The plurality of heads may output inferences including one or more road object classifications and one or more road object attributes. A head may have an output layer that can generate these inferences (e.g., as numerical values). The heads may include respective deep neural networks.

Because some road objects may have dynamic features or have certain characteristic kinematics, one or more temporal layers (e.g., temporal networks) may be included between the shared backbone and the heads. Temporal layers may help the road object understanding model to learn features that are dynamic or learn kinematic features (across multiple frames of input data). Ability to learn these features can help with road object classification and extraction of road object attributes, e.g., paper material, drivability, animal can fly, rigidity, etc. The temporal network may include recurrent neural networks. The temporal network may include long short-term memory networks. Depending on the head (e.g., the task corresponding to the head), a temporal network upstream of the head may or may not be needed. Depending on the head (e.g., the task corresponding to the head), the temporal network upstream of the head may be configured differently (e.g., omitting an input gate, omitting a forget gate, omitting an output gate, omitting an input activation function, omitting an output activation function, coupled input and forget gate, no peepholes, full gate recurrence, varying sequence length etc.). Some heads may share the same temporal network. Some heads may have dedicated temporal networks.

FIG. 5 illustrates an exemplary architecture for the road object understanding sub-model 304, according to some aspects of the disclosed technology. FIG. 6 illustrates another exemplary architecture for the road object understanding sub-model 304, according to some aspects of the disclosed technology. In both figures, the road object understanding sub-model 304 may include a shared backbone 502, and plurality of heads. The heads may include two or more of: road object classification head 522, animal classification head 524, drivability head 532, rigidity head 534, emptiness head 536, material head 538, and traffic sign head 540. Collectively, drivability head 532, rigidity head 534, emptiness head 536, material head 538 may be part of debris attributes heads 526.

In FIG. 5, the road object understanding sub-model 304 may include a plurality of temporal networks to process an output from the shared backbone 502 and to (individually) generate outputs to respective heads. Temporal network 504 may process an output from shared backbone 502 and generate an output to road object classification head 522. Temporal network 506 may process an output from shared backbone 502 and generate an output to animal classification head 524. Temporal network 506 may process an output from shared backbone 502 and generate an output to debris attributes heads 526 (in some cases, two or more ones of the debris attributes heads 526 may share the temporal network 508). Temporal network 510 may process an output from shared backbone 502 and generate an output to traffic sign head 540.

In FIG. 5, the road object understanding sub-model 304 may include a first temporal network (e.g., temporal network 504, temporal network 506, or temporal network 510) to process an output from the shared backbone 502 and to generate an output to a first head of the plurality of heads (e.g., road object classification head 522, animal classification head 524, or traffic sign head 540). The road object understanding sub-model 304 may include a second temporal network (e.g., temporal network 508) to process the output from the shared backbone 502 and to generate an output to a plurality of second heads of the plurality of heads (e.g., two or more ones of the debris attributes heads 526).

In FIG. 6, the road object understanding sub-model 304 may include a shared temporal network 602 coupled to receive an output from the shared backbone 502 and to generate an output to the plurality of heads. The shared temporal network 602 may require less computational resources but may have less ability to capture task-specific features, when compared to the road object understanding sub-model 304 of FIG. 5.

In FIGS. 5 and 6, the road object classification head 522 may output a road object subtype inference. The road object subtype inference may select between (or output probability values that a given tracked object having an unknown object classification belongs to) two or more of the following: debris classification, animal classification, construction object classification, sign classification, and vulnerable road user classification. The road object classification head 522 may generate a road object subtype inference that selects a classification between two or more of the following: debris classification, animal classification, construction object classification, sign classification, and vulnerable road user classification.

In FIGS. 5 and 6, the animal classification head 524 may output an animal subtype inference. The animal subtype inference may select between (or output probability values that a given tracked object having an unknown object classification belongs to) an animal can fly classification and an animal cannot fly classification. The animal subtype inference may indicate a probability that the tracked object having an unknown object classification is an animal that can fly. The animal classification head 524 may generate an animal subtype inference that selects a classification between an animal can fly classification and an animal cannot fly classification.

In FIGS. 5 and 6, a first debris attribute head (e.g., drivability head 532) may generate and output a drivability probability (indicating a likelihood that an AV can drive over a given tracked object having an unknown object classification). The first debris attribute head may, in some embodiments, output a drivability inference that selects between a drivable classification and a non-drivable classification.

In FIGS. 5 and 6, a second debris attribute head (e.g., rigidity head 534) may generate and output a rigidity probability (indicating a likelihood that a given tracked object having an unknown object classification is hard). The second debris attribute head may, in some embodiments, output a rigidity inference that selects between a hard object classification and a soft object classification.

In FIGS. 5 and 6, a third debris attribute head (e.g., emptiness head 536) may output an emptiness probability (indicating a likelihood that a given tracked object having an unknown object classification is empty). The second debris attribute head may, in some embodiments, generate and output an emptiness inference that selects between an empty object classification and a full object classification.

In FIGS. 5 and 6, a fourth debris attribute head (e.g., material head 538) may generate and output a material inference. The material inference may select between (or output probability values that a given tracked object having an unknown object classification belongs to) two or more of the following: cardboard classification, fabric classification, foliage classification, metal classification, paper classification, plastic classification, stone classification, wood classification, unknown material classification.

In FIGS. 5 and 6, the traffic sign head 540 may generate and output a traffic sign inference. The traffic sign inference may select between (or output probability values that a given tracked object having an unknown object classification belongs to) two or more of the following: a road closed sign classification, a stop sign classification, a keep left sign classification, a keep right sign classification, a double arrow sign classification, and unknown sign classification. In some cases, the traffic sign head 540 may output one or more attributes in the form of one or more probability values that indicate likelihood of a given tracked object with an unknown object classification having one or more attributes. Attributes may include a road closed attribute, a stop attribute, a keep left attribute classification, a keep right attribute classification, a double arrow attribute, etc. In some cases, the traffic sign (subtype) inference may be provided to a traffic directives understanding part (e.g., traffic directives understanding sub-model 306).

### Exemplary Method for Understanding Road Users and Road Objects

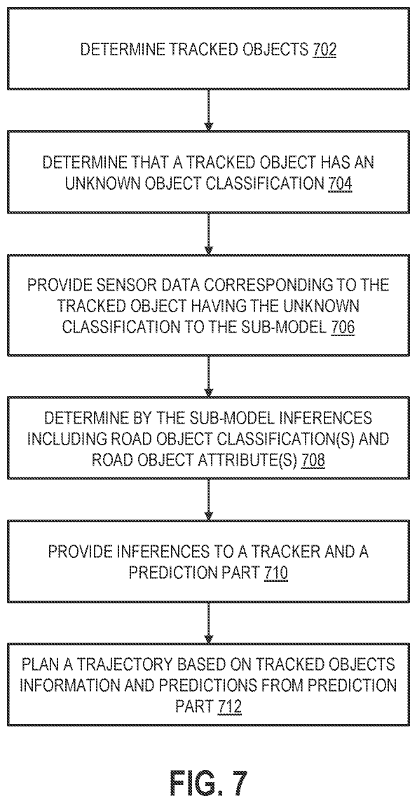

FIG. 7 illustrates an exemplary method for understanding road users and road objects and controlling a vehicle based on the understanding, according to some aspects of the disclosed technology. The method may be carried out by components illustrated in the figures. In 702, a tracker or tracking part may determine tracked objects in an environment of the vehicle. In 704, a main understanding model may determine a tracked object has an unknown object classification. In 706, sensor data corresponding to the tracked object having the unknown object classification may be provided to a (road object understanding) sub-model. In 708, the sub-model may determine a plurality of inferences based on the sensor data. Determining the plurality of inferences can include processing the sensor data using a shared backbone, and generating inferences by a plurality of heads that are downstream of the backbone. The inferences may include one or more road object classifications and one or more road object attributes. In 710, the inferences may be provided to a tracker that collects the inferences of the tracked objects and a prediction part that predicts behaviors of the tracked objects. In 712, a trajectory of the vehicle may be planned, e.g., by a planning part, based on tracked objects information from the tracker and predictions from the prediction part.

In some embodiments, determining the tracked objects may include determining bounding boxes of the tracked objects in the environment of the vehicle based on sensor data.

In some embodiments, the main understanding model can produce a road user inference that selects between road user classifications and an unknown object classification.

In some embodiments, the sensor data corresponding to the tracked object having the unknown object classification may include an image cropped based on a projection of a bounding box corresponding to the tracked object onto a camera image (captured by sensors of the AV).

In some embodiments, determining the plurality of inferences may include processing an output of the shared backbone by one or more temporal networks. Determining the plurality of inferences can further include processing an output of the shared backbone by a plurality of temporal networks dedicated to generating separate outputs to the plurality of heads. Various configurations of temporal networks are illustrated in FIGS. 5 and 6.

### Exemplary AV Management System

Turning now to FIG. 8, this figure illustrates an example of an AV management system 800, in which some of the aspects of the present disclosure can be implemented. One of ordinary skill in the art will understand that, for the AV management system 800 and any system discussed in the present disclosure, there may be additional or fewer components in similar or alternative configurations. The illustrations and examples provided in the present disclosure are for conciseness and clarity. Other embodiments may include different numbers and/or types of elements, but one of ordinary skill the art will appreciate that such variations do not depart from the scope of the present disclosure.

In this example, the AV management system 800 includes an AV 130, a data center 850, and a client computing device 870. The AV 130, the data center 850, and the client computing device 870 may communicate with one another over one or more networks (not shown), such as a public network (e.g., the Internet, an Infrastructure as a Service (IaaS) network, a Platform as a Service (PaaS) network, a Software as a Service (SaaS) network, another Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

AV 130 may navigate about roadways without a human driver based on sensor signals generated by multiple sensor systems 804, 806, and 808. The sensor systems 804-808 may include different types of sensors and may be arranged about the AV 130. For instance, the sensor systems 804-808 may comprise Inertial Measurement Units (IMUs), cameras (e.g., still image cameras, video cameras, thermal cameras, signal cameras, etc.), light sensors (e.g., light detecting and ranging (LIDAR) systems, ambient light sensors, infrared sensors, etc.), RADAR systems, a Global Navigation Satellite System (GNSS) receiver, (e.g., Global Positioning System (GPS) receivers), audio sensors (e.g., microphones, Sound Navigation and Ranging (SONAR) systems, ultrasonic sensors, etc.), time-of-flight sensors, structured light sensor, infrared sensors, signal light sensors, thermal imaging sensors, engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 804 may be a camera system, the sensor system 806 may be a LIDAR system, and the sensor system 808 may be a RADAR system. Other embodiments may include any other number and type of sensors.

AV 130 may also include several mechanical systems that may be used to maneuver or operate AV 130. For instance, mechanical systems may include vehicle propulsion system 830, braking system 832, steering system 834, safety system 836, and cabin system 838, among other systems. Vehicle propulsion system 830 may include an electric motor, an internal combustion engine, or both. The braking system 832 may include an engine brake, a wheel braking system (e.g., a disc braking system that utilizes brake pads), hydraulics, actuators, and/or any other suitable componentry configured to assist in decelerating AV 130. The steering system 834 may include suitable componentry configured to control the direction of movement of the AV 130 during navigation. Safety system 836 may include lights and signal indicators, a parking brake, airbags, and so forth. The cabin system 838 may include cabin temperature control systems, in-cabin entertainment systems, and so forth. In some embodiments, the AV 130 may not include human driver actuators (e.g., steering wheel, handbrake, foot brake pedal, foot accelerator pedal, turn signal lever, window wipers, etc.) for controlling the AV 130. Instead, the cabin system 838 may include one or more client interfaces (e.g., GUIs, Voice User Interfaces (VUIs), etc.) for controlling certain aspects of the mechanical systems 830-838.

AV 130 may additionally include a local computing device 810 that is in communication with the sensor systems 804-808, the mechanical systems 830-838, the data center 850, and the client computing device 870, among other systems. The local computing device 810 may include one or more processors and memory, including instructions that may be executed by the one or more processors. The instructions may make up one or more software stacks or components responsible for controlling the AV 130; communicating with the data center 850, the client computing device 870, and other systems; receiving inputs from riders, passengers, and other entities within the AV's environment; logging metrics collected by the sensor systems 804-808; and so forth. In this example, the local computing device 810 includes a perception, understanding, and tracking part 104, a mapping and localization stack 814, a prediction part 106, a planning part 110, and controls part 112, a communications stack 820, an HD geospatial database 822, and an AV operational database 824, among other stacks and systems.

Perception, understanding, and tracking part 104 may enable the AV 130 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 804-808, the mapping and localization stack 814, the HD geospatial database 822, other components of the AV, and other data sources (e.g., the data center 850, the client computing device 870, third-party data sources, etc.). The perception, understanding, and tracking part 104 may detect and classify objects and determine their current and predicted locations, speeds, directions, and the like. In addition, the perception, understanding, and tracking part 104 may determine the free space around the AV 130 (e.g., to maintain a safe distance from other objects, change lanes, park the AV, etc.). The perception, understanding, and tracking part 104 may also identify environmental uncertainties, such as where to look for moving objects, flag areas that may be obscured or blocked from view, and so forth. Exemplary implementations of perception, understanding, and tracking part 104 are illustrated in the figures.

Prediction part 106 may predict behaviors and movements of tracked objects sensed by perception, understanding, and tracking part 104.

Mapping and localization stack 814 may determine the AV's position and orientation (pose) using different methods from multiple systems (e.g., GPS, IMUs, cameras, LIDAR, RADAR, ultrasonic sensors, the HD geospatial database 822, etc.). For example, in some embodiments, the AV 130 may compare sensor data captured in real-time by the sensor systems 804-808 to data in the HD geospatial database 822 to determine its precise (e.g., accurate to the order of a few centimeters or less) position and orientation. The AV 130 may focus its search based on sensor data from one or more first sensor systems (e.g., GPS) by matching sensor data from one or more second sensor systems (e.g., LIDAR). If the mapping and localization information from one system is unavailable, the AV 130 may use mapping and localization information from a redundant system and/or from remote data sources.

Planning part 110 may determine how to maneuver or operate the AV 130 safely and efficiently in its environment. For instance, the planning part 110 may produce a plan for the AV 130, which can include a (reference) trajectory. Planning part 110 may receive information generated by perception, understanding, and tracking part 104. For example, the planning part 110 may receive the location, speed, and direction of the AV 130, geospatial data, data regarding objects sharing the road with the AV 130 (e.g., pedestrians, bicycles, vehicles, ambulances, buses, cable cars, trains, traffic lights, lanes, road markings, etc.) or certain events occurring during a trip (e.g., an Emergency Vehicle (EMV) blaring a siren, intersections, occluded areas, street closures for construction or street repairs, DPVs, etc.), user input, and other relevant data for directing the AV 130 from one point to another. The planning part 110 may determine multiple sets of one or more mechanical operations that the AV 130 may perform (e.g., go straight at a specified speed or rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning part 110 may select from multiple backup plans to carry out. For example, while preparing to change lanes to turn right at an intersection, another vehicle may aggressively cut into the destination lane, making the lane change unsafe. The planning part 110 could have already determined an alternative plan for such an event, and upon its occurrence, help to direct the AV 130 to go around the block instead of blocking a current lane while waiting for an opening to change lanes.

Controls part 112 may manage the operation of the vehicle propulsion system 830, the braking system 832, the steering system 834, the safety system 836, and the cabin system 838. Controls part 112 may receive a plan from the planning part 110. Controls part 112 may receive sensor signals from the sensor systems 804-808 as well as communicate with other stacks or components of the local computing device 810 or a remote system (e.g., the data center 850) to effectuate the operation of the AV 130. For example, controls part 112 may implement the final path or actions from the multiple paths or actions provided by the planning part 110. The implementation may involve turning the plan from the planning part 110 into commands for vehicle hardware controls such as the actuators that control the AV's steering, throttle, brake, and drive unit.

The communication stack 820 may transmit and receive signals between the various stacks and other components of the AV 130 and between the AV 130, the data center 850, the client computing device 870, and other remote systems. The communication stack 820 may enable the local computing device 810 to exchange information remotely over a network. Communication stack 820 may also facilitate local exchange of information, such as through a wired connection or a local wireless connection.

The HD geospatial database 822 may store HD maps and related data of the streets upon which the AV 130 travels. In some embodiments, the HD maps and related data may comprise multiple layers, such as an areas layer, a lanes and boundaries layer, an intersections layer, a traffic controls layer, and so forth. The areas layer may include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer may include geospatial information of road lanes (e.g., lane or road centerline, lane boundaries, type of lane boundaries, etc.) and related attributes (e.g., direction of travel, speed limit, lane type, etc.). The lanes and boundaries layer may also include 3D attributes related to lanes (e.g., slope, elevation, curvature, etc.). The intersections layer may include geospatial information of intersections (e.g., crosswalks, stop lines, turning lane centerlines, and/or boundaries, etc.) and related attributes (e.g., permissive, protected/permissive, or protected only left-turn lanes; permissive, protected/permissive, or protected only U-turn lanes; permissive or protected only right-turn lanes; etc.). The traffic controls layer may include geospatial information of traffic signal lights, traffic signs, and other road objects and related attributes.

The AV operational database 824 may store raw AV data generated by the sensor systems 804-808 and other components of the AV 130 and/or data received by the AV 130 from remote systems (e.g., the data center 850, the client computing device 870, etc.). In some embodiments, the raw AV data may include HD LIDAR point cloud data, image or video data, RADAR data, GPS data, and other sensor data that the data center 850 may use for creating or updating AV geospatial data as discussed further below with respect to FIG. 5 and elsewhere in the present disclosure.

Data center 850 may be a private cloud (e.g., an enterprise network, a co-location provider network, etc.), a public cloud (e.g., an IaaS network, a PaaS network, a SaaS network, or other CSP network), a hybrid cloud, a multi-cloud, and so forth. The data center 850 may include one or more computing devices remote to the local computing device 810 for managing a fleet of AVs and AV-related services. For example, in addition to managing the AV 130, the data center 850 may also support a ridesharing service, a delivery service, a remote/roadside assistance service, street services (e.g., street mapping, street patrol, street cleaning, street metering, parking reservation, etc.), and the like.

The data center 850 may send and receive various signals to and from the AV 130 and the client computing device 870. These signals may include sensor data captured by the sensor systems 804-808, roadside assistance requests, software updates, ridesharing pick-up and drop-off instructions, and so forth. In this example, the data center 850 includes one or more of a data management platform 852, an Artificial Intelligence/Machine Learning (AI/ML) platform 854, a remote assistance platform 858, a ridesharing platform 860, and a map management platform 862, among other systems.

Data management platform 852 may be a “big data” system capable of receiving and transmitting data at high speeds (e.g., near real-time or real-time), processing a large variety of data, and storing large volumes of data (e.g., terabytes, petabytes, or more of data). The varieties of data may include data having different structures (e.g., structured, semi-structured, unstructured, etc.), data of different types (e.g., sensor data, mechanical system data, ridesharing service data, map data, audio data, video data, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs. enterprise systems, social networks, etc.), data having different rates of change (e.g., batch, streaming, etc.), or data having other heterogeneous characteristics. The various platforms and systems of data center 850 may access data stored by the data management platform 852 to provide their respective services.

The AI/ML platform 854 may provide the infrastructure for training and evaluating machine learning algorithms for operating the AV 130, the remote assistance platform 858, the ridesharing platform 860, the map management platform 862, and other platforms and systems. Using the AI/ML platform 854, data scientists may prepare data sets from the data management platform 852; select, design, and train machine learning models; evaluate, refine, and deploy the models; maintain, monitor, and retrain the models; and so on.

The remote assistance platform 858 may generate and transmit instructions regarding the operation of the AV 130. For example, in response to an output of the AI/ML platform 854 or other system of the data center 850, the remote assistance platform 858 may prepare instructions for one or more stacks or other components of the AV 130.

The ridesharing platform 860 may interact with a customer of a ridesharing service via a ridesharing application 872 executing on the client computing device 870. The client computing device 870 may be any type of computing system, including a server, desktop computer, laptop, tablet, smartphone, smart wearable device (e.g., smart watch; smart eyeglasses or other Head-Mounted Display (HMD); smart ear pods or other smart in-car, on-car, or over-ear device; etc.), gaming system, or other general-purpose computing device for accessing the ridesharing application 872. The client computing device 870 may be a customer's mobile computing device or a computing device integrated with the AV 130 (e.g., the local computing device 810). The ridesharing platform 860 may receive requests to be picked up or dropped off from the ridesharing application 872 and dispatch the AV 130 for the trip.

Map management platform 862 may provide a set of tools for the manipulation and management of geographic and spatial (geospatial) and related attribute data. The data management platform 852 may receive LIDAR point cloud data, image data (e.g., still image, video, etc.), RADAR data, GPS data, and other sensor data (e.g., raw data) from one or more AVs 802. Unmanned Acrial Vehicles (UAVs), satellites, third-party mapping services, and other sources of geospatially referenced data.

In some embodiments, the map viewing services of map management platform 862 may be modularized and deployed as part of one or more of the platforms and systems of the data center 850. For example, the AI/ML platform 854 may incorporate the map viewing services for visualizing the effectiveness of various object detection or object classification models, the remote assistance platform 858 may incorporate the map viewing services for replaying traffic incidents to facilitate and coordinate aid, the ridesharing platform 860 may incorporate the map viewing services into the client application 872 to enable passengers to view the AV 130 in transit enroute to a pick-up or drop-off location, and so on.

### Exemplary Processor-Based System

FIG. 9 illustrates an exemplary computing system with which some aspects of the subject technology may be implemented. For example, processor-based system 900 may be any computing device making up, or any component thereof in which the components of the system are in communication with each other using connection 905. Connection 905 may be a physical connection via a bus, or a direct connection into processor 910, such as in a chipset architecture. Connection 905 may also be a virtual connection, networked connection, or logical connection.

In some embodiments, computing system 900 represents the local computing device 810 of FIG. 8. In some embodiments, one or more of the described system components represents many such components each performing some or all of the function for which the component is described. In some embodiments, the components may be physical or virtual devices.

Exemplary system 900 includes at least one processor 910 and connection 905 that couples various system components including system memory 915, such as Read-Only Memory (ROM) 920 and Random-Access Memory (RAM) 925 to processor 910. at least one processor 910 may include one or more of: Central Processing Unit (CPU), Graphical Processing Unit (GPU), machine learning processor, neural network processor, or some other suitable computing processor. Computing system 900 may include a cache of high-speed memory 912 connected directly with, in close proximity to, or integrated as part of processor 910.

Processor 910 may include any general-purpose processor and a hardware service or software service. Processor 910 may essentially be a completely self-contained computing system, containing multiple cores or processors, a bus, memory controller, cache, etc. A multi-core processor may be symmetric or asymmetric.

Storage device 930 may be a non-volatile and/or non-transitory and/or computer-readable memory device and may be a hard disk or other types of computer-readable media which may store data that is accessible by a computer.

Storage device 930 may include software services, servers, services, etc., that when the code that defines such software is executed by the processor 910, it causes the system 900 to perform a function. Storage device 930 may include instructions that implement functionalities of perception, understanding, and tracking part 104, prediction part 106, planning part 110, and controls part 112 as illustrated in the figures. In some embodiments, a hardware service that performs a particular function may include the software component stored in a computer-readable medium in connection with the necessary hardware components, such as processor 910, connection 905, output device 935, etc., to carry out the function.

To enable user interaction, computing system 900 includes an input device 945, which may represent any number of input mechanisms, such as a microphone for speech, a touch-sensitive screen for gesture or graphical input, keyboard, mouse, motion input, speech, etc. Computing system 900 may also include output device 935, which may be one or more of a number of output mechanisms known to those of skill in the art. In some instances, multimodal systems may enable a user to provide multiple types of input/output to communicate with computing system 900. Computing system 900 may include communications interface 940, which may generally govern and manage the user input and system output. The communication interface may perform or facilitate receipt and/or transmission of wired or wireless communications via wired and/or wireless transceivers.

Embodiments within the scope of the present disclosure may also include tangible and/or non-transitory computer-readable storage media or devices for carrying or having computer-executable instructions or data structures stored thereon. Such tangible computer-readable storage devices may be any available device that may be accessed by a general-purpose or special-purpose computer, including the functional design of any special-purpose processor as described above. By way of example, and not limitation, such tangible computer-readable devices may include RAM, ROM, EEPROM, CD-ROM or other optical disk storage, magnetic disk storage or other magnetic storage devices, or any other device which may be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special-purpose computer, or special-purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

The various embodiments described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure. Claim language reciting “at least one of” a set indicates that one member of the set or multiple members of the set satisfy the claim.

### Select Examples

Example 1 is a vehicle comprising: sensors; one or more processors; and one or more storage media encoding instructions executable by the one or more processors to implement an understanding part, wherein the understanding part includes: a main understanding model to classify a tracked object into one of: a plurality of road user classifications and an unknown object classification; and a sub-model including: a shared backbone to receive and process sensor data generated from the sensors corresponding to tracked objects having the unknown object classification; and a plurality of heads to output inferences including one or more road object classifications and one or more road object attributes.

In Example 2, the vehicle of Example 1 can optionally include the sub-model further including: a plurality of temporal networks to process an output from the shared backbone and to generate outputs to respective heads.

In Example 3, the vehicle of Example 1 or 2 can optionally include the sub-model further including: a first temporal network to process an output from the shared backbone and to generate an output to a first head of the plurality of heads; and a second temporal network to process the output from the shared backbone and to generate an output to a plurality of second heads of the plurality of heads.

In Example 4, the vehicle of Example 1 can optionally include the sub-model further including: a shared temporal network coupled to receive an output from the shared backbone and to generate an output to the plurality of heads.

In Example 5, the vehicle of any one of Examples 1-4 can optionally include the plurality of heads including: a road object classification head to output a road object subtype inference.

In Example 6, the vehicle of Example 5 can optionally include the road object subtype inference selecting between two or more of the following: debris classification; animal classification; construction object classification; sign classification; and vulnerable road user classification.

In Example 7, the vehicle of any one of Examples 1-6 can optionally include the plurality of heads including: an animal classification head to output an animal subtype inference.

In Example 8, the vehicle of Example 7 can optionally include the animal subtype inference selecting between an animal can fly classification and an animal cannot fly classification.

In Example 9, the vehicle of any one of Examples 1-8 can optionally include the plurality of heads including: a first debris attribute head to output a drivability probability.

In Example 10, the vehicle of any one of Examples 1-9 can optionally include the plurality of heads including a second debris attribute head to output a rigidity probability.

In Example 11, the vehicle of any one of Examples 1-10 can optionally include the plurality of heads including: a third debris attribute head to output an emptiness inference that selects between an empty object classification and a full object classification.

In Example 12, the vehicle of any one of Examples 1-11 can optionally include the plurality of heads including: a fourth debris attribute head to output a material inference.

In Example 13, the vehicle of Example 12 can optionally include the material inference selecting between two or more of the following: cardboard classification; fabric classification; foliage classification; metal classification; paper classification; plastic classification; stone classification; wood classification; and unknown material classification.

In Example 14, the vehicle of any one of Examples 1-13 can optionally include the plurality of heads including: a traffic sign head to output a traffic sign inference.

In Example 15, the vehicle of Example 14 can optionally include the traffic sign inference selecting between two or more of the following: a road closed sign classification; a stop sign classification; a keep left sign classification; a keep right sign classification; a double arrow sign classification; and unknown sign classification.

In Example 16, the vehicle of Example 14 or 15 can optionally include: the one or more storage encoding instructions executable by the one or more processors further implementing a planning part; the understanding part further including a traffic directives understanding sub-model; and the traffic directive sub-model part receiving the traffic sign inference from the traffic sign head and producing one or more traffic directives to the planning part.

In Example 17, the vehicle of any one of Examples 1-16 can optionally include the one or more storage encoding instructions executable by the one or more processors further implementing a tracking part to produce bounding boxes of tracked objects in an environment of the vehicle.

In Example 18, the vehicle of Example 17 can optionally include the bounding boxes of tracked objects being provided to the understanding part.

In Example 19, the vehicle of any one of Examples 1-18 can optionally include the sensor data from the sensors corresponding to the tracked objects having the unknown object classification comprising images cropped based on projections of bounding boxes of the tracked objects having the unknown object classification onto camera images captured by the sensors.

In Example 20, the vehicle of any one of Examples 17-19 can optionally include the inferences of the understanding part being provided to the tracking part.

In Example 21, the vehicle of any one of Examples 1-20 can optionally include the one or more storage encoding instructions executable by the one or more processors further implementing a prediction part to receive at least one of the inferences generated by the plurality of heads and to predict behaviors of tracked objects in an environment of the vehicle based on the at least one of the inferences.

In Example 22, the vehicle of any one of Examples 1-21 can optionally include the one or more storage encoding instructions executable by the one or more processors further implementing a planning part to receive at least one of the inferences generated by the plurality of heads and to generate a trajectory for the vehicle.

Example 23 is a computer-implemented method for understanding road users and road objects and controlling a vehicle based on the understanding, the method comprising: determining, by a tracker, tracked objects in an environment of the vehicle; determining, by a main understanding model, that a tracked object has an unknown object classification; providing sensor data corresponding to the tracked object having the unknown object classification to a sub-model; and determining, by the sub-model, a plurality of inferences based on the sensor data, wherein determining the plurality of inferences comprises: processing the sensor data using a shared backbone; and generating inferences by a plurality of heads that are downstream of the backbone, the inferences including one or more road object classifications and one or more road object attributes; providing the inferences to a tracker that collects the inferences of the tracked objects and a prediction part that predicts behaviors of the tracked objects; and planning a trajectory of the vehicle based on tracked objects information from the tracker and predictions from the prediction part.

In Example 24, the computer-implemented method of Example 23 can optionally include determining the tracked objects comprising determining bounding boxes of the tracked objects in the environment of the vehicle based on sensor data.

In Example 25, the computer-implemented method of Example 23 or 24 can optionally include the main understanding model producing a road user inference that selects between road user classifications and an unknown object classification.

In Example 26, the computer-implemented method of any one of Examples 23-25 can optionally include the sensor data corresponding to the tracked object having the unknown object classification comprising an image cropped based on a projection of a bounding box corresponding to the tracked object onto a camera image.

In Example 27, the computer-implemented method of any one of Examples 23-26 can optionally include determining the plurality of inferences further comprising: processing an output of the shared backbone by one or more temporal networks.

In Example 28, the computer-implemented method of any one of Examples 23-27 can optionally include determining the plurality of inferences further comprising: processing an output of the shared backbone by a plurality of temporal networks dedicated to generate separate outputs to the plurality of heads.

In Example 29, the computer-implemented method of any one of Examples 23-28 can optionally include generating the inferences by the plurality of heads comprising: generating, by a road object classification head of the plurality of heads, a road object subtype inference that selects a classification between two or more of the following: debris classification, animal classification, construction object classification, sign classification, and vulnerable road user classification.

In Example 30, the computer-implemented method of any one of Examples 23-29 can optionally include generating the inferences by the plurality of heads comprising: generating, by an animal classification head of the plurality of heads, an animal subtype inference that selects a classification between an animal can fly classification and an animal cannot fly classification.

In Example 31, the computer-implemented method of any one of Examples 23-30 can optionally include generating the inferences by the plurality of heads comprising: generating, by a first debris attribute head, a drivability probability.

In Example 32, the computer-implemented method of any one of Examples 23-31 can optionally include generating the inferences by the plurality of heads comprising: generating, by a second debris attribute head, a rigidity probability.

In Example 33, the computer-implemented method of any one of Examples 23-32 can optionally include generating the inferences by the plurality of heads comprising: generating, by a third debris attribute head, an emptiness inference that selects between an empty object classification and a full object classification.

In Example 34, the computer-implemented method of any one of Examples 23-33 can optionally include generating the inferences by the plurality of heads comprising: generating, by a fourth debris attribute head, a material inference that selects between two or more of the following: cardboard classification, fabric classification, foliage classification, metal classification, paper classification, plastic classification, plastic classification, stone classification, and wood classification.

In Example 35, the computer-implemented method of any one of Examples 23-34 can optionally include generating the inferences by the plurality of heads comprising: generating, by a traffic sign head to output a traffic sign inference that selects between two or more of the following: a road closed sign classification, a stop sign classification, a keep left sign classification, a keep right sign classification, a double arrow sign classification, and an unknown sign classification.

In Example 36, the computer-implemented method of Example 35 can optionally include: providing the traffic sign inference to a traffic directives understanding part.

Example 37 includes one or more non-transitory computer-readable media storing instructions that, when executed by one or more processors, cause the one or more processors to perform any one of the computer-implemented methods of Examples 23-36.

Example 38 is an apparatus comprising means to carry out any one of the computer-implemented methods of Examples 23-36.

What is claimed is:

1. A vehicle comprising:
sensors;
one or more processors; and
one or more storage media encoding instructions executable by the one or more processors to implement an understanding part, wherein the understanding part includes:
a main understanding model to classify a tracked object into one of: a plurality of road user classifications and an unknown object classification; and
a sub-model including:
a shared backbone to receive and process sensor data generated from the sensors corresponding to tracked objects having the unknown object classification; and
a plurality of heads to output inferences including one or more road object classifications and one or more road object attributes.

2. The vehicle of claim 1, wherein the sub-model further includes:
a plurality of temporal networks to process an output from the shared backbone and to generate outputs to respective heads.

3. The vehicle of claim 1, wherein the sub-model further includes:
a first temporal network to process an output from the shared backbone and to generate an output to a first head of the plurality of heads; and
a second temporal network to process the output from the shared backbone and to generate an output to a plurality of second heads of the plurality of heads.

4. The vehicle of claim 1, wherein the sub-model further includes:
a shared temporal network coupled to receive an output from the shared backbone and to generate an output to the plurality of heads.

5. The vehicle of claim 1, wherein the plurality of heads include:
a road object classification head to output a road object subtype inference.

6. The vehicle of claim 5, wherein the road object subtype inference selects between two or more of the following:
debris classification;
animal classification;
construction object classification;
sign classification; and
vulnerable road user classification.

7. The vehicle of claim 1, wherein the plurality of heads include:
an animal classification head to output an animal subtype inference.

8. The vehicle of claim 7, wherein the animal subtype inference selects between an animal can fly classification and an animal cannot fly classification.

9. The vehicle of claim 1, wherein the plurality of heads include:
a first debris attribute head to output a drivability probability.

10. The vehicle of claim 1, wherein the plurality of heads include:
a second debris attribute head to output a rigidity probability.

11. The vehicle of claim 1, wherein the plurality of heads include:
a third debris attribute head to output an emptiness inference that selects between an empty object classification and a full object classification.

12. The vehicle of claim 1, wherein the plurality of heads include:
a fourth debris attribute head to output a material inference.

13. The vehicle of claim 12, wherein the material inference selects between two or more of the following:
cardboard classification;
fabric classification;
foliage classification;
metal classification;
paper classification;
plastic classification;
stone classification;
wood classification; and
unknown material classification.

14. The vehicle of claim 1, wherein the plurality of heads include:
a traffic sign head to output a traffic sign inference.

15. The vehicle of claim 14, wherein the traffic sign inference selects between two or more of the following:
a road closed sign classification;
a stop sign classification;
a keep left sign classification;
a keep right sign classification;
a double arrow sign classification; and
unknown sign classification.

16. A computer-implemented method for understanding road users and road objects and controlling a vehicle based on the understanding, the method comprising:
determining, by a tracker, tracked objects in an environment of the vehicle;
determining, by a main understanding model, that a tracked object has an unknown object classification;
providing sensor data corresponding to the tracked object having the unknown object classification to a sub-model;
determining, by the sub-model, a plurality of inferences based on the sensor data, wherein determining the plurality of inferences comprises:
processing the sensor data using a shared backbone; and
generating inferences by a plurality of heads that are downstream of the backbone, the inferences including one or more road object classifications and one or more road object attributes;
providing the inferences to a tracker that collects the inferences of the tracked objects and a prediction part that predicts behaviors of the tracked objects; and
planning a trajectory of the vehicle based on tracked objects information from the tracker and predictions from the prediction part.

17. The computer-implemented method of claim 16, wherein determining the tracked objects comprises determining bounding boxes of the tracked objects in the environment of the vehicle based on sensor data.

18. The computer-implemented method of claim 16, wherein the main understanding model produces a road user inference that selects between road user classifications and an unknown object classification.

19. The computer-implemented method of claim 16, wherein the sensor data corresponding to the tracked object having the unknown object classification comprises an image cropped based on a projection of a bounding box corresponding to the tracked object onto a camera image.

20. One or more non-transitory computer-readable media storing instructions that, when executed by one or more processors, cause the one or more processors to:
determine, by a tracker encoded in the instructions, tracked objects in an environment of a vehicle;
determine, by a main understanding model encoded in the instructions, that a tracked object has an unknown object classification;
provide sensor data corresponding to the tracked object having the unknown object classification to a sub-model encoded in the instructions;
determine, by the sub-model, a plurality of inferences based on the sensor data, wherein determining the plurality of inferences comprises:
processing the sensor data using a shared backbone encoded in the instructions; and
generating inferences by a plurality of heads encoded in the instructions that are downstream of the backbone, the inferences including one or more road object classifications and one or more road object attributes;
provide the inferences to a tracker encoded in the instructions that collects the inferences of the tracked objects and a prediction part encoded in the instructions that predicts behaviors of the tracked objects; and
plan a trajectory of the vehicle based on tracked objects information from the tracker and predictions from the prediction part.
